(19) United States
(12) Patent Application Publication
(10) Pub. No.: US 2015/0155814 A1
(43) Pub. Date: Jun. 4, 2015

(54) VIBRATION GENERATING DEVICE

(71) Applicant: Tokyo Parts Industrial Co., Ltd., Gunma-ken (JP)

(72) Inventor: Masahiro NISHIDATE, Gunma-ken (JP)

(21) Appl. No.: 14/467,593

(22) Filed: Aug. 25, 2014

(30) Foreign Application Priority Data
Nov. 29, 2013 (JP) 2013-248230

(51) Int. Cl. H02P 25/02; A61H 23/00; H02K 33/00

(52) U.S. Cl. CPC H02P 25/027; H02K 33/00; A61H 23/00

(57) ABSTRACT

The vibration generating device comprises a first member which has a first contact part and a second member which has a second contact part arranged spaced apart from the first member; a tilt support member which supports the second member so as to be able to tilt with respect to the first member; and a vibration generating member which is fixed to the first member or the second member. When the first member or the second member tilts such that the first contact part makes contact with the second contact part, the vibration generating member vibrates differently depending on the direction in which the first member or the second member tilts.

### TECHNICAL FIELD

The present invention relates to a vibration generating device used in a massage device.

### BACKGROUND OF THE INVENTION

In terms of a vibration massage devices, for example, Japanese Patent Laid Open Publication Number 1998-234840 describes a device comprising, as shown in FIG. 7, a local protrusion unit 101 for locally stimulating a human body; a drive shaft 102, which is coupled to that side of the local protrusion unit 101 that does not make contact with the human body, and which extends over a predetermined length; a wide area protrusion unit 103, for stimulating the human body across a wide area, the apex positions of the protrusions in which are substantially the same as the apex position of the local protrusion 101, and which is provided so as to able to slide with respect to the drive shaft 102; a support unit 104, integrally provided on the drive shaft 102 for elastically supporting the wide area protrusions 103; and a drive unit for driving the drive shaft 102 in the axial direction.

This wide area protrusion unit moves only in the axial direction, and when operated from the axial direction, the power switch is turned on by the movement of the wide area protrusion unit in the axially downward direction, which activates the drive unit and transmits vibration to the human body.

However, because the structure is such that the power switch is turned on by operating the wide area protrusion unit in the axial direction, in the event that the amount of vibration produced by the drive unit is to be changed, while a configuration in which a plurality of power switches at differing operation positions is conceivable, there is a problem in that the device will become complicated.

### SUMMARY OF THE INVENTION

The present invention provides a vibration generating device capable of solving the problems described above, which were found in the prior art. Hereafter, aspects of the present invention directed to solving the problems described above are described. Note that, in the aspects described below, the constituent elements employed can be used in the most freely chosen combinations possible.

In order to solve the problems described above, the present invention is a vibration generating device comprising:
a first member having a first contact part;
a second member having a second contact part arranged spaced apart from the first member;
a tilt support member, which supports the second member so as to be able to tilt with respect to the first member; and
a vibration generating member fixed to the first member or the second member,
wherein, when the first member or the second member tilts such that the first contact part and the second contact part make contact, the vibration generating member is activated differently depending on the direction in which the first member or the second member tilts.

More preferred characteristics of the vibration generating device of the present invention are:
“the first contact part or the second contact part comprises a plurality of independent electroconductive patterns formed along a circumferential direction; and
a DC voltage is applied to the vibration generating part, which depends on the electroconductive pattern that conducts with the first contact part when the second member is tilted,”
“the first contact part or the second contact part is formed from a C-shaped resistive pattern; and
a DC voltage that has been voltage divided with the resistive pattern is applied to the vibration generating member when the second member has been tilted such that the first contact part and the second contact part make contact,”
“the first contact part or the second contact part has an antivibration member,”
“the first contact part or the second contact part is formed from an electrically conductive soft material,” and
“the first member or the second member is flexible.”

With the vibration generating device of the present invention, when the first member or the second member is tilted in a given direction and contact is made between the contact parts, the vibration generating member will be activated and the amount of vibration generated by the vibration generating member will change depending on the direction in which the first member or the second member tilts, in addition to which, because the first member and the second member themselves, which are provided with contacts, take the place of a plurality of power switches, this has a simple configuration which nonetheless allows the amount of vibration to be easily changed when the device is activated.

### BRIEF DESCRIPTION OF THE DRAWINGS

FIG. 1 is a vibration generating device according to a first exemplary mode of embodiment of the present invention, wherein (a) is a plan view and (b) is a sectional view in the direction of the arrows, along the line p-p.

FIG. 2(a) is a sectional view in the direction of the arrows along the line q-q in FIG. 1(b), and FIG. 2(b) is a sectional view showing the situation during operations in FIG. 1(b).

FIG. 3 is an electrical connection diagram of a vibration generating device according to the first exemplary mode of embodiment of the present invention.

FIG. 4 is a sectional view showing the initial state of a vibration generating device according to a second exemplary mode of embodiment of the present invention.

FIG. 5 is a sectional view showing the initial state of a vibration generating device according to a third exemplary mode of embodiment of the present invention.

FIG. 6 is an electrical connection diagram of a vibration generating device according to a fourth exemplary mode of embodiment of the present invention.

FIG. 7 is a drawing describing a conventional vibration massage device.

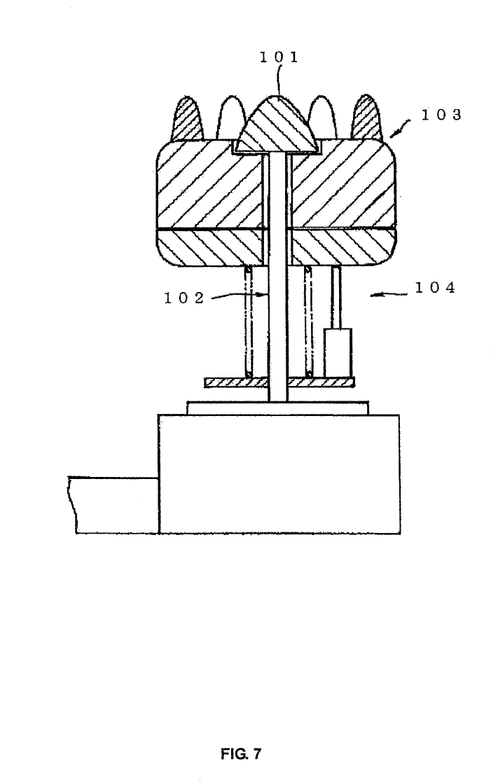

### DETAILED DESCRIPTION OF THE PREFERRED EMBODIMENTS

Hereafter, in order to more concretely illustrate the present invention, modes of embodiment of the present invention are described in detail with reference to the drawings.

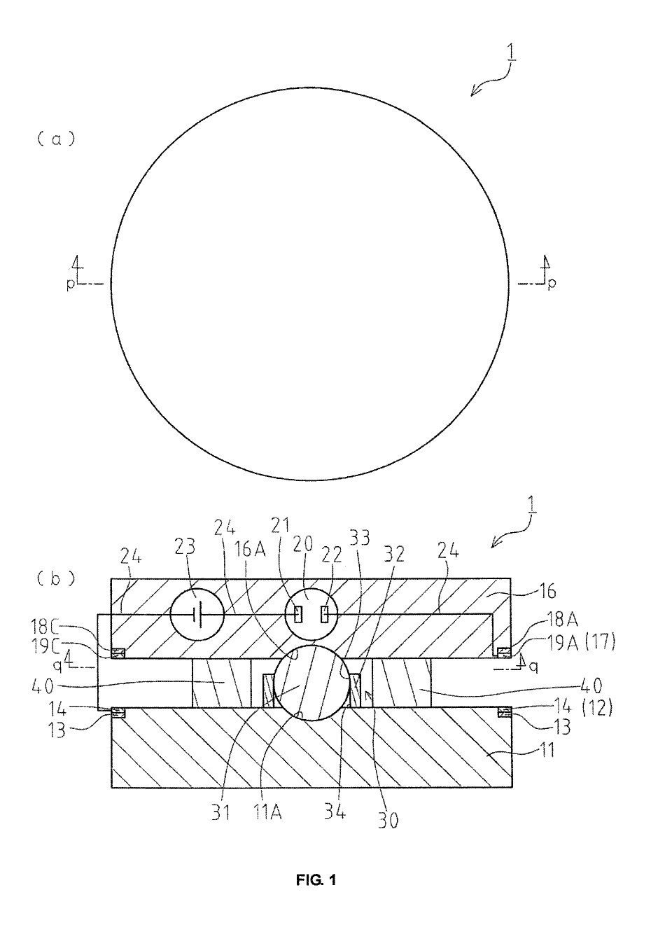

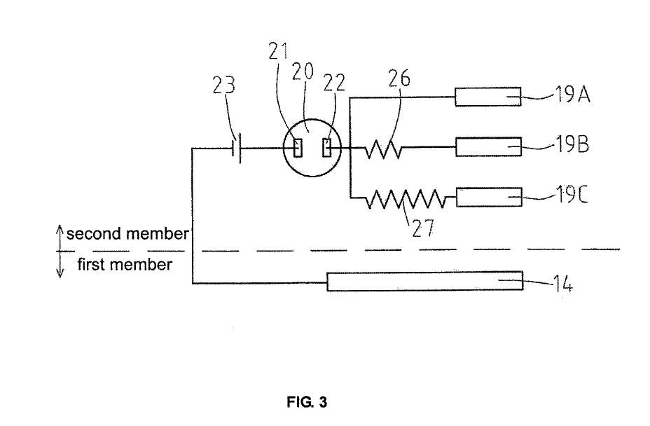

A vibration generating device 1 according to a first exemplary mode of embodiment of the present invention will be described referring to FIG. 1 through FIG. 3.

The vibration generating device 1 in this example is used as a massage device, which serves to vibrate the human body, which constitutes the object to be vibrated (for example, a sole of a foot P). Specifically, when the sole of the foot P is placed on the vibration generating device 1, the sole of the foot P is massaged by way of vibration.

The vibration generating device 1 in this example comprises a first member 11, a second member 16, a vibration generating member 20, a tilt support member 30, and an elastic member 40.

The sole of the foot P is placed on the first member 11 and the second member 16. The first member 11 and the second member 16 are formed from a flexible insulating resin allowing for a slight deformation when the sole of the foot P is placed thereon, and are formed from planar disks, the outer dimensions of which are larger than the sole of the foot P. Note that it is possible for only one of either the first member 11 or the second member 16 to be flexible.

In this example, the second member 16, on which the sole of the foot P is placed, is arranged above the first member 11, substantially parallel thereto and facing the first member 11 spaced apart therefrom by a predetermined amount, such that the overall shape of the vibration generating device 1 is substantially plate-like. A first electroconductive contact part 12 is provided at the outer periphery of the first member 11, and a second electroconductive contact part 17 is provided at the outer periphery of the second member 16.

Specifically, a ring shaped printed circuit board 13 is provided on the top face of the first member 11, around the entire outer periphery thereof, and a ring-shaped electroconductive pattern 14, which serves as the first contact part 12, is provided on the top face of this printed circuit board 13. The top face of this electroconductive pattern 14 is formed level with the top face of the first member 11.

The electroconductive pattern 14 that constitutes the first contact part 12 is electrically connected to one of the terminals 21 of the vibration generating member 20, which is described hereafter, by a lead line 24, with a power source 23 therebetween.

Furthermore, three independent printed circuit boards 18A, 18B, 18C are arranged in a ring shape at the outer periphery of the bottom face of the second member 16 and electroconductive patterns 19A, 19B, 19C, constituting the second contact part 17, are respectively provided on the bottom faces of these printed circuit boards 18A, 18B, 18C. That is to say, the three independent electroconductive patterns 19A, 19B, 19C are aligned in the circumferential direction on the bottom face of the second member 16, and the bottom faces of these electroconductive patterns 19A, 19B, 19C are formed level with the bottom face of the second member 16.

Then, the second contact part 17 is electrically connected to another terminal 22 of the vibration generating member 20, which will be described hereafter, by way of a lead line 24.

Specifically, the electroconductive pattern 19A comprised by the second contact part 17 is electrically connected to the other terminal 22 by way of the lead line 24. Furthermore, the electroconductive pattern 19B comprised by the second contact part 17 is electrically connected to the other terminal 22, via a first resistor 26, by way of the lead line 24. Furthermore, the electroconductive pattern 19C comprised by the second contact part 17 is electrically connected to the other terminal 22, via a second resistor 27 having a greater resistance than the first resistor 26, by way of the lead line 24,

Note that, in this example, a ring-shaped electroconductive pattern 14 is provided on the top face of the first member 11 and three independent electroconductive patterns 19A, 19B, 19C are provided on the bottom face of the second member 16, but this arrangement may be reversed, such that three independent electroconductive patterns are provided on the top face of the first member 11, and a ring-shaped electroconductive pattern is provided on the bottom face of the second member 16. In this case, the vibration generating member 20 and the power source 23 are provided in the second member 16.

The vibration generating member 20 serves to generate vibration. The vibration generating member 20 in this example is provided with a non-illustrated vibration motor on which an eccentric weight is mounted. This vibration generating member 20 is fastened within the second member 16 and transmits the vibration generated to the second member 16. Furthermore, the vibration generating member 20 has first and second terminals 21, 22. The first terminal 21 is electrically connected to the first contact part 12, which is provided at the outer periphery of the first member 11. The second terminal 22 is electrically connected to the electroconductive patterns 19A, 19B, 19C of the second contact part 17, which is provided at the outer periphery of the second member 16.

The power source 23 serves to supply power to the vibration generating member 20 and comprises, for example, a primary cell or a secondary cell. This power source 23 is, for example, fastened within the second member 16.

The tilt support member 30 serves to support the second member 16 so as to be able tilt in any direction, through 360°, with respect to the first member 11.

The tilt support member 30 in this example comprises a non-electroconductive hard sphere 31, a first portion of which is fixed to the second member 16, and a receiving cylinder 32, which is fixed to the first member 11, and into which a second portion of the sphere 31 is fitted, allowing for tilting.

Specifically, the first portion of the sphere 31 is fixed in place with an adhesive in a recess 16a that is provided in the bottom face of the second member 16, such that when the second member 16 tilts, the sphere 31 will tilt united therewith.

A recess 11A, having a depth that is less than the radius of the sphere, is formed in the top face of the first member 11, and the second portion of the sphere 31 is arranged in the recess 11A. Furthermore, the receiving cylinder 32 comprises an annular upper opening 33 at the top and an annular lower opening 34 at the bottom, and is fixed to the first member 11 by non-illustrated screws, such that the lower opening 34 covers the recess 11A in the first member 11.

The lower opening 34 is formed somewhat larger than the diameter of the sphere 31 so that the sphere 31 can be inserted via the lower opening 34, and can tilt. Note that lubricating oil is applied to the receiving cylinder 32 that makes contact with the sphere 31 and to the recess 11A in the first member 11, so as to facilitate tilting of the sphere 31.

The upper opening 33 is formed such that the inner diameter thereof is less than the diameter of the sphere 31, and the structure is such that the sphere 31 that has been inserted into the interior of the receiving cylinder 32 will not come out from the top of the receiving cylinder 32. That is to say, the second member 16 is arranged so as to be able to tilt with respect to the first member 11, and the second member 16 has a structure that prevents separation from the first member 11.

Thus, when the sole of the foot P is placed on the second member 16, the second member 16 can tilt with respect to the first member 11, with the sphere 31 as a pivot. That is to say, the second member 16 can tilt in any direction, through 360°, with respect to the first member 11, as a result of the same operational force at any position on the outer periphery of the second member 16, with the second portion of the sphere 31 making sliding contact with the recess 11A in the first member 11. Furthermore, when the second member 16 tilts, a corner of the second contact part 17 makes line contact with the top face of the first contact part 12.

Note that, in this example, even if the first member 11 and the second member 16 were arranged in a manner that is vertically reversed from that which is shown in FIG. 1, and the sole of the foot P were placed on the first member 11, the first member 11 would be able to tilt with respect to the second member 16, by way of the tilt support member 30.

When the sole of the foot P is placed on the second member 16 and the second member 16 tilts by way of the tilt support member 30, an elastic member 40 is compressed and elastically deformed, but when the sole of the foot P is removed from the second member 16, the second member 16 and the first member 11 will return to the initial state, spaced apart by a predetermined about, by virtue of the restoring force of the elastic member 40. In this initial state, the elastic member 40 is not elastically deformed, and the second contact part 17 is not in contact with the first contact part 12.

The elastic member 40 in this example is configured as a ring-shaped cushion member. This elastic member 40 is arranged between the first member 11 and the second member 16. Specifically, the elastic member 40 is arranged at the peripheral exterior of the sphere 31 and to the peripheral interior of the first contact part 12 (second contact part 17). Furthermore, the thickness of the elastic member 40 is less than the diameter of the sphere 31. Furthermore, the elastic member 40 is fixed only to the first member 11, so that the second member 16 can readily tilt with respect to the first member 11. Note that the elastic member 40 may also be fixed only to the second member 16.

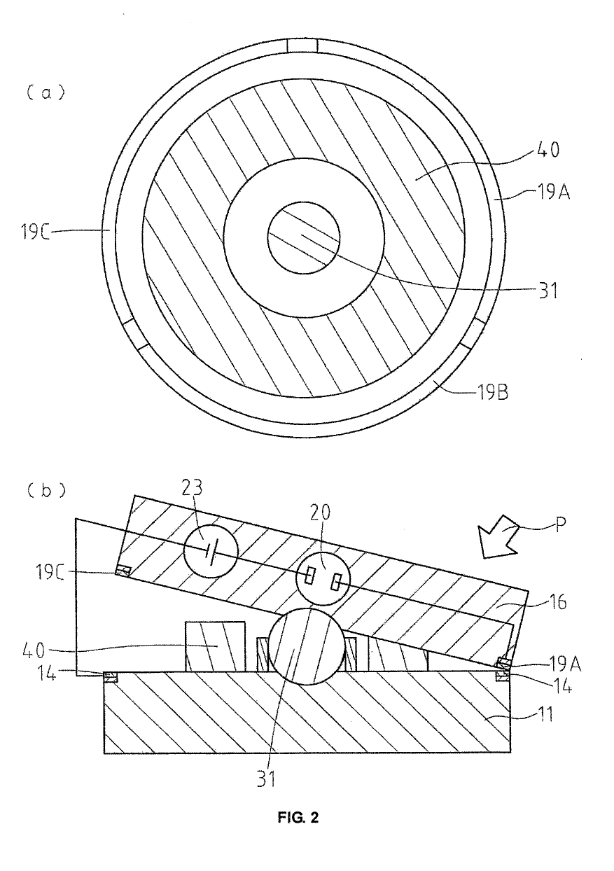

With the vibration generating device in this example, which is configured as described above, when the sole of the foot P is placed on the second member 16 from a diagonally transverse direction (for example the diagonally transverse direction in FIG. 2(b)), the second member 16 tilts in a given direction with respect to the first member 11, by way of the tilt support member 30, such that a portion of the elastic member 40 is compressed and elastically deformed and the second contact part 17 makes contact with the first contact part 12. Thereupon, the vibration generating member 20 is electrically connected to the power source 23 and activated, so as to provide vibration to the sole of the foot P. At this point, the vibration generating member 20 is differently activated depending on the direction of tilt of the second member 16.

Specifically, when the second member 16 has been tilted in a given direction, the electroconductive pattern 19A constituting the second contact part 17 makes contact with the electroconductive pattern 14 constituting the first contact part 12, whereupon the vibration generating member 20 is directly electrically connected to the power source 23, and activated.

Furthermore, when the second member 16 tilts in a other given direction, the electroconductive pattern 19B that constitutes the second contact part 17 makes contact with the electroconductive pattern 14 that constitutes the first contact part 12, whereupon the vibration generating member 20 is electrically connected to the power source via the first resistor 26 and a DC voltage that has been voltage divided with the first resistor 26 is applied to the vibration generating member 20, activating the vibration generating member 20.

Furthermore, when the second member 16 tilts in a yet other given direction, the electroconductive pattern 19C that constitutes the second contact part 17 makes contact with the electroconductive pattern 14 that constitutes the first contact part 12, whereupon the vibration generating member 20 is electrically connected to the power source via a second resistor 27 having a resistance that is greater than that of the first resistor 26, and a DC voltage that has been voltage divided with the second resistor 27 is applied to the vibration generating member 20, activating the vibration generating member.

Thus, with the electroconductive pattern 19A, the electroconductive pattern 19B and the electroconductive pattern 19C, the amount of vibration generated by the vibration generating member 20 progressively decreases, Accordingly, when the first contact part 12 and the second contact part 17 make contact, a DC voltage will be applied to the vibration generating member 20, which corresponds to the electroconductive pattern that is conducting, whereby the vibration generating member 20 vibrates differently depending on the direction in which the second member 16 tilts.

Thereafter, when the sole of the foot P is removed from the second member 16, the second contact part 17 is separated from the first contact part 12 as a result of the restoring force of the elastic member 40, such that voltage ceases to be applied to the vibration generating member 20, stopping the operation of the vibration generating member 20, and the second member 16 and the first member 11 return to the initial state.

Thus, the vibration generating device 1 in this example comprises: the first member 11, which has the first contact part 12; and the second member 16, which has the second contact part 17 arranged spaced apart from the first member 11; the tilt support member 30, which supports the second member 16 so as to be able to tilt with respect to the first member 11; and the vibration generating member 20, which is fixed to the first member 11 or the second member 16. Furthermore, when the first member 11 or the second member 16 tilts such that the first contact part 12 makes contact with the second contact part 17, the vibration generating member 20 vibrates differently depending on the direction in which the first member 11 or the second member 16 tilts.

Accordingly, when first member 11 or the second member 16 tilts in a given direction such that contact is made between the contact parts, the vibration generating member 20 will be activated and the amount of vibration generated by the vibration generating member 20 will change depending on the direction in which the first member 11 or the second member 16 tilts, in addition to which, because the first member 11 and the second member 16 themselves, which are provided with contacts, take the place of a plurality of power switches, the vibration generating device in this example has a simple configuration which nonetheless allows the amount of vibration to be easily changed when the device is activated.

Furthermore, with the conventional configuration, the wide area protrusions moved only in the axial direction, and if the device was operated from a transverse direction that was inclined with respect to the axial direction, the wide area protrusions would not readily move in the axially downward direction, which tended to degrade the responsiveness, with possible limitations on applications therefor. Meanwhile, in this example, when the second member 16 is operated from a diagonally transverse direction and thus tilted, the second contact part 17 and the first contact part 12 are brought into contact by the same operational force at any position on the outer periphery of the second member 16, activating the vibration generating member 20, whereby the operational range is expanded without degrading responsiveness.

Furthermore, when the arrangement of the first member 11 and the second member 16 is vertically reversed with respect to that in FIG. 1, and the first member 11 is operated from a diagonally transverse direction so as to be tilted, the first member 11 tilts with respect to the second member 16, by way of the tilt support member 30. Thereupon, the first contact part 12 and the second contact part 17 make contact, and of the vibration generating member 20 that is fixed to the second member 16 vibrates. Then, this vibration is transmitted to the second member 16, the tilt support member 30 and the first member 11, such that vibration is transmitted to the sole of the foot P that is in contact with the first member 11. Thus, when the first member 11 is operated from a diagonally transverse direction and thus tilted, the first contact part 12 and the second contact part 17 are brought into contact by the same operational force at any position on the outer periphery of the first member 11, activating the vibration generating member 20, whereby the operational range is expanded without degrading responsiveness.

Furthermore, in this example the first contact part 12 or the second contact part 17 comprises the plurality of independent electroconductive patterns 19A, 19B, 19C, which are formed along the circumferential direction, and DC voltages that correspond to the conducting electroconductive patterns are applied to the vibration generating member 20.

For this reason, the amount of vibration generated by the vibration generating member 20 changes depending on the direction in which the first member 11 or the second member 16 tilts.

Furthermore, in this example, the first member 11 or the second member 16 is flexible and therefore, as compared to a case in which the first member 11 and the second member 16 are formed from a hard material, conduction failure between the contacts during vibration can be reduced.

Note that, in the foregoing description, the vibration generating member 20 and the power source 23 are fixed to the second member 16, but so long as the configuration is such that the vibration generating device is activated when the first contact part 12 and the second contact part 17 make contact, the vibration generating member 20 and the power source 23 may be fixed to the first member 11, rather than on the second member 16.

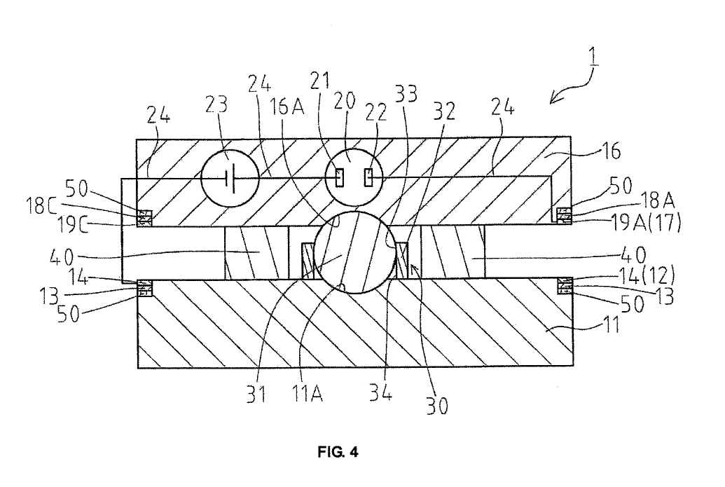

The contact parts in a vibration generating device according to a second exemplary mode of embodiment of the present invention will be described with reference to FIG. 4. In FIG. 4, reference numerals that are the same as the reference numerals in FIG. 1 to FIG. 3 indicate the same members, and thus detailed descriptions are omitted.

The vibration generating device in this example is one wherein an antivibration member 50 has been added to the contact part 17 of the first exemplary mode of embodiment. Specifically, the second contact part 17 is provided at the outer periphery of the bottom face of the second member 16 with rubber, serving as an antivibration member 50, therebetween. Here, this example has an effect similar to that in the first exemplary mode of embodiment, and is able to further reduce conduction failure between contact parts during vibration. Note that the configuration may also be such that the antivibration member in this example is provided on the first contact part 12, rather than being provided on the second contact part 17.

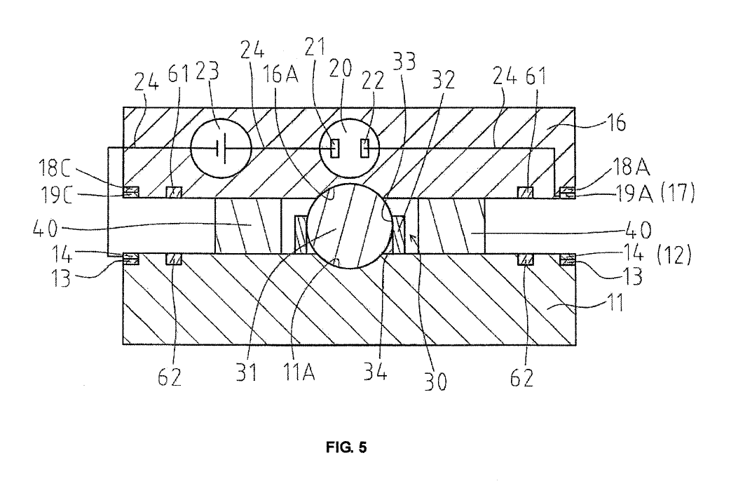

The contact parts in a vibration generating device according to a third exemplary mode of embodiment of the present invention will be described with reference to FIG. 5. In FIG. 5, reference numerals that are the same as the reference numerals in FIG. 1 to FIG. 4 indicate the same members, and thus detailed descriptions are omitted.

The vibration generating device in this example is one wherein magnetic attraction members have been added to the second member 16 and the first member 11 of the first exemplary mode of embodiment. The magnetic attraction members in this example are a ring-shaped magnet 61, which is provided on the second member 16, and a ring-shaped magnetic body 62, which is provided on the first member 11, facing the magnet 61, and which is attracted to the magnet 61.

Specifically, the magnet 61 is arranged at the peripheral interior of the second contact part 17, and at the peripheral exterior of the elastic member 40, embedded in the bottom face of the second member 16. Furthermore, the magnetic body 62 is arranged at the peripheral interior of the first contact part 12, and at the peripheral exterior of the elastic member 40, embedded in the top face of the first member 11. The attractive force resulting from the magnetic attraction members in this example is less than the restorative force that returns the elastic member 40, which has been compressed and elastically deformed by the second member 16, to the initial state.

Here, when the second member 16 tilts so that the second contact part 17 and the first contact part 12 make contact, the magnetic attraction members in this example increase the contact pressure between the second contact part 17 and the first contact part 12, and thus reduce conduction failure between the contact parts. Thereafter, when the sole of the foot P is removed from the second member 16, the second contact part 17 is separated from the first contact part 12 as a result of the restoring force of the elastic member 40, such that voltage ceases to be applied to the vibration generating member 20, stopping the operation of the vibration generating member 20, and the second member 16 and the first member 11 return to the initial state. Here, this example has an effect similar to that in the first exemplary mode of embodiment, and is able to further reduce conduction failure between contact parts during vibration. The magnetic attraction members in this example are not limited to the configuration described above and may have another configuration, so long as this is a configuration with which the second member 16 is magnetically attracted to the first member 11 as a result of tilting of the second member 16.

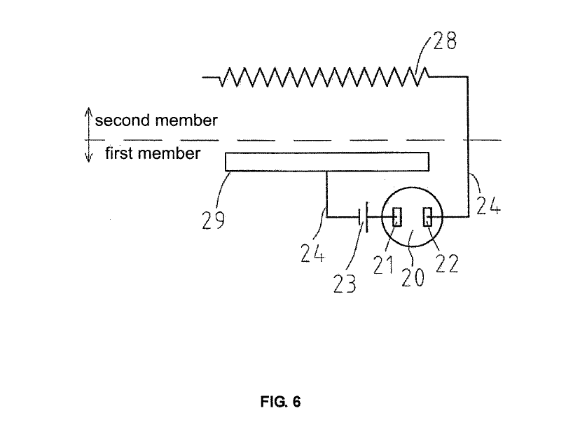

The contact parts in a vibration generating device according to a fourth exemplary mode of embodiment of the present invention will be described with reference to the electrical wiring diagram in FIG. 6. In FIG. 6, reference numerals that are the same as the reference numerals in FIG. 1 to FIG. 5 indicate the same members, and thus detailed descriptions are omitted.

In the first exemplary mode of embodiment, independent electroconductive patterns 19A, 19B, 19C are formed at the outer periphery of the bottom face of the second member 16, and a ring-shaped electroconductive pattern 14 is formed at the outer periphery of the top face of the first member 11, but in this example, a C-shaped electrically conductive resistive pattern 28 is formed at the outer periphery of the bottom face of the second member 16 and a C-shaped electroconductive pattern 29 is formed facing the resistive pattern 28, at the outer periphery of the top face of the first member 11.

In the case of this example, the vibration generating member 20 and the power source 23 are provided in the first member 11, which is provided with the electroconductive pattern 29. Next, one terminal 21 of the vibration generating member 20 is connected to the C-shaped electroconductive pattern 29, with the power source 23 therebetween. Furthermore, the other terminal 22 of the vibration generating member 20 is connected to one end of the resistive pattern 28, with a lead wire 24.

Thus, when the second member 16 tilts in a given direction such that a portion of the resistive pattern 28 makes contact with the electroconductive pattern 29, the vibration generating member 20 is electrically connected to the power source 23, and activated. At this point, because DC power that has been voltage divided with the resistive pattern 28 is applied to the vibration generating member 20, a voltage corresponding to the direction in which the second member 16 tilts is applied to the vibration generating member 20, such that the amount of vibration generated by the vibration generating member varies depending on the direction in which the second member tilts. Thus, this example has an effect similar to that of the first exemplary mode of embodiment.

Note that, in this example, the C-shaped electrically conductive resistive pattern 28 is formed at the outer periphery of the bottom face of the second member 16 and the C-shaped electroconductive pattern 29 is formed facing the resistive pattern 28 at the outer periphery of the top face of the first member 11, but the configuration may also be such that this arrangement is reversed and the C-shaped electrically conductive resistive pattern is formed at the outer periphery of the top face of the first member 11 while the C-shaped electroconductive pattern is formed facing this resistive pattern at the outer periphery of the bottom face of the second member 16. In this case, the vibration generating member 20 and the power source 23 are provided in the first member 11.

Furthermore, contact parts that are different from those in the first exemplary mode of embodiment may be used in the vibration generating device of the present invention. In the first exemplary mode of embodiment, the first contact part 12 and the second contact part 17 were formed from electroconductive patterns, but these may also be formed from a soft electrically conductive material such as electroconductive rubber. Here, this example has an effect similar to that in the first exemplary mode of embodiment, and is able to reduce conduction failure between contact parts during vibration.

Furthermore, contact parts that are different from those in the first exemplary mode of embodiment may be used in the vibration generating device of the present invention. In the first exemplary mode of embodiment, when the second member 16 was tilted, a corner of the second contact part 17 made line contact with the top face of the first member 12, but in this example, the second contact part has an inclined face that extends upward to the exterior, with respect to the bottom face of the second member 16, and when the second member 16 tilts, the top face of the first contact part 12 makes surface contact. Here, this example has an effect similar to that in the first exemplary mode of embodiment, and is able to reduce conduction failure between contact parts during vibration. Note that, the contact part in this example may be configured so as to be provided on the first member 11 rather than the second member 16. In this case, the first contact part 12 has an inclined face that extends downward to the exterior, with respect to the top face of the first member 11.

Note that, in the foregoing description, the overall shape of the vibration generating device comprising a plate shaped first member 11 and a plate shaped second member 16 is approximately plate shaped, but the vibration generating device may have an overall shape that is approximately spherical by way of forming the first member 11 and the second member 16 as hemispheres and arranging these with the convexities of the hemispheres oriented outward.

Furthermore, in the foregoing description, the tilt support member 30 comprises a sphere having a first portion that is fixed to the second member 16 and a receiving cylinder that is fixed to the first member 11, and in which a second portion of the sphere is fitted therein so as to be able to tilt, but the tilt support member may also be a coil spring having a first end fixed to the first member and a second end fixed to the second member. In this case, the elastic member described above is not fixed to the first member or the second member.

Furthermore, in the foregoing description, the tilt support member 30 comprises a sphere having a first portion that is fixed to the second member 16 and a receiving cylinder that is fixed to the first member 11 and in which a second portion of the sphere is fitted therein so as to be able to tilt, but the tilt support member may also comprise a sphere having a first portion that is fixed to the first member 11 and a receiving cylinder that is fixed to the second member 16 and in which a second portion of the sphere is fitted therein so as to be able to tilt.

What is claimed is:

1. A vibration generating device comprising:
a first member having a first contact part;
a second member having a second contact part, arranged spaced apart from the first member;
a tilt support member which supports the second member so as to be able to tilt with respect to the first member; and
a vibration generating member fixed to the first member or the second member,
wherein, when the first member or the second member tilts such that the first contact part and the second contact part make contact, the vibration generating member is activated differently depending on the direction in which the first member or the second member tilts.

2. The vibration generating device according to claim 1, wherein the first contact part or the second contact part comprises a plurality of independent electroconductive patterns formed along a circumferential direction; and
a DC voltage is applied to the vibration generating part, which depends on the electroconductive pattern that conducts with the first contact when the second member tilts.

3. The vibration generating device according to claim 1, wherein the first contact part or the second contact part is formed from a C-shaped resistive pattern; and
a DC voltage that has been voltage divided with the resistive pattern is applied to the vibration generating member when the second member has been tilted such that the first contact part and the second contact part make contact.

4. The vibration generating device according to claim 1, wherein the first contact part or the second contact part has an antivibration member.

5. The vibration generating device according to claim 1, wherein the first contact part or the second contact part is formed from an electrically conductive soft material,

6. The vibration generating device according to claim 1, wherein the first member or the second member is flexible.
